(19) United States
(12) Patent Application Publication
(10) Pub. No.: US 2021/0337081 A1
(43) Pub. Date: Oct. 28, 2021

(54) PROCESSING FACSIMILE IN CLOUD SERVER

(71) Applicant: Hewlett-Packard Development Company, L.P., Spring, TX (US)

(72) Inventors: Chang Min HAN, Seongnam-si (KR); Hee Sang KWON, Seongnam-si (KR); Young Dae JANG, Seongnam-si (KR)

(21) Appl. No.: 17/273,837

(22) PCT Filed: Jan. 29, 2020
(86) PCT No.: PCT/US2020/015649

§ 371 Date: Mar. 5, 2021

(30) Foreign Application Priority Data
Jun. 10, 2019 (KR) 10-2019-0068139

(51) Int. Cl. H04N 1/327; H04N 1/00

(52) U.S. Cl. CPC H04N 1/32776; H04N 1/32702; H04N 1/32789; H04N 1/00244

(57) ABSTRACT

A cloud server including a memory, a communication device, and a processor. The memory storing address information of a user terminal device corresponding to a subscriber. The communication device to receive fax data. The processor to, in response to receiving the fax data for the subscriber, control the communication device to notify the user terminal device a fax was received based on the address information of the user terminal device, and in response to receiving a request to output the received fax data, control the communication device to transmit the received fax data to an image forming apparatus designated by the subscriber.

### BACKGROUND

An image forming apparatus means an apparatus for printing print data generated in a terminal device such as a computer on a recording paper, and a representative example of the image forming apparatus is a copier, a printer, a facsimile, a multifunction peripheral (MFP) that combines the functions thereof, or the like.

A facsimile refers to a device which converts a recording image such as a character, a chart, and a photo into an electrical signal, transmits the electrical signal through a telephone line, and restores the same to an original image. As such, a facsimile has a facsimile number and a facsimile module connected to a public switched telephone network (PSTN) in that the facsimile uses a telephone line.

### BRIEF DESCRIPTION OF THE DRAWINGS

FIG. 1 is a block diagram illustrating an image forming system according to an example;

FIG. 2 is a block diagram illustrating a configuration of a user terminal device according to an example;

FIG. 3 is a block diagram illustrating a configuration of an image forming apparatus according to an example;

FIG. 4 is a block diagram illustrating a simple configuration of a cloud server according to an example;

FIG. 5 is a block diagram illustrating a detailed configuration of a cloud serve according to an example;

FIG. 6 is a view illustrating an example of account information stored in the memory of FIG. 4;

FIG. 7 is a flowchart to describe a fax notification method in a user terminal device according to an example;

FIG. 8 is a flowchart to describe a fax notification method in a cloud server according to an example; and

FIG. 9 is a flowchart to describe a method of outputting fax data according to an example.

### DETAILED DESCRIPTION

Hereinafter, various examples will be described in detail with reference to the drawings. The examples described below may be modified and implemented in various different forms. In order to more clearly describe the features of the examples, a detailed description of known matters to those skilled in the art will be omitted.

Meanwhile, in the present specification, when an element is referred to as being “connected” with another element, it may include a case of being directly connected, but may also include a case of being connected with another element in between. Also, when an element is referred to as “including” another element, it means that the element may not exclude another element but may further include other elements, unless specifically stated otherwise.

In the present specification, the term “image forming job” may mean various jobs (e.g., printing, scanning or faxing) related to an image, such as forming the image or generating/storing/transmitting an image file, and the term “job” may mean the image forming job but may also mean a series of processes necessary for performing the image forming job.

Also, the term “image forming apparatus” refers to an apparatus that prints print data generated by a terminal device such as a computer on a recording paper. Examples of such an image forming apparatus include a copier, a printer, a facsimile, or a multi-function printer (MFP) that combines functions thereof through a single apparatus.

In addition, the term “print data” may mean data converted into a printable format by the printer. Meanwhile, when the printer supports direct printing, the file itself may be print data.

The term “fax data” refers to data used for transceiving a fax service, and may refer to print data before being converted into a data format suitable for the PSTN network or data converted to a data format suitable for the PSTN network. For example, the fax data may be data having a fax format (modified huffman (MH)/modified read (MR)/modified modified read (MMR)/joint bi-level image exports group (JBIG)/joint photographic coding experts group (JPEG)) conforming to the fax transmission specification (T.30 Protocol).

Also, the term “user” may mean a person who performs an operation related to the image forming operation using an image forming apparatus or a device connected with the image forming apparatus by wire or wirelessly.

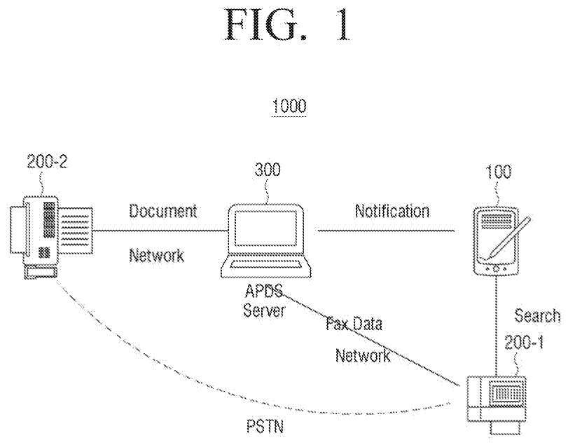

FIG. 1 is a block diagram illustrating an image forming system according to an example.

Referring to FIG. 1, an image forming system 1000 according to an example may include a user terminal device 100, a reception-side image forming apparatus 200-1, a transmission-side image forming apparatus 200-2, and a cloud server 300.

The cloud server 300 may perform a job based on user information. Here, a method for performing a job based on user information means a method of performing a job even if a user of a transmission side (or a user of a reception side) does not know a facsimile (hereinafter, “fax”) number of the reception-side image forming apparatus 200-1, by mapping address information of an image forming apparatus to be used by the user by user information or information of a user terminal device used by the user and registering the mapped address information to a cloud server.

That is, printing (or fax transmission) may be performed by selecting a pre-registered user (name, user telephone number), instead of directly selecting a network address (or a fax number) of a device for performing printing (or fax transmission). As such, a cloud server 300 operating based on the user information may be referred to as an automatically printer discovery solution (APDS) server.

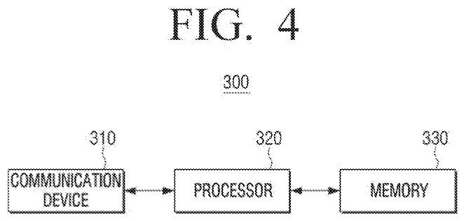

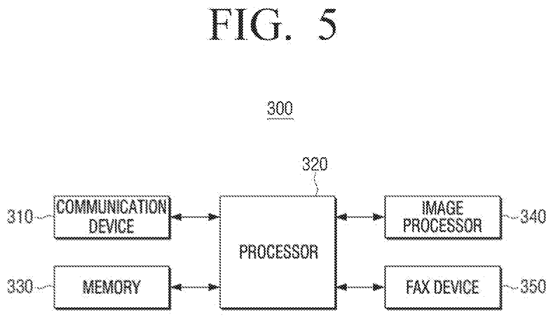

The cloud server 300 may store various information provided by a user terminal device 100, and when receiving the fax data from the transmission-side image forming apparatus 200-2, the cloud server 300 may perform fax notification to the user terminal device 100, and fax data transmission to the reception-side image forming apparatus 200-1 based on the stored information. Examples of functions and operations of the cloud server 300 will be described below with reference to FIGS. 4 and 5.

The user terminal device 100 may provide user information and address information of the image forming apparatus 200-1 to be used by the user to the cloud server 300. If the user terminal device 100 receives a notification from the cloud server 300 that the fax data is received, the user terminal device 100 may notify the user of it.

Here, the user information is information which may specify a user, including account information (for example, ID, name, employee number, or the like) for accessing the system of the cloud server 300 and address (IP address, telephone number, or the like) of a user terminal device used by the user.

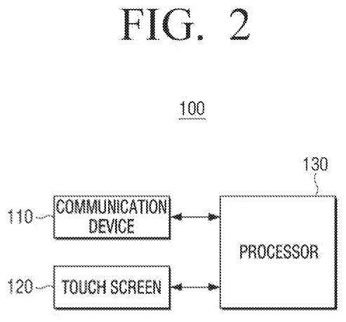

The user terminal device 100 may request the cloud server 300 to output the notified fax data at a timing when the fax output (or print) is necessary. An example of a function and operation of the user terminal device 100 will be described with reference to FIG. 2 below.

The image forming apparatus 200 may perform an image forming apparatus function. When the image forming apparatus 200 performs a fax transmission function, the image forming apparatus 200 may transmit fax data to the cloud server 300 as the transmission-side image forming apparatus 200-2 of FIG. 1. At this time, the transmission-side image forming apparatus 200-2 may perform the fax transmission using the user information (for example, name or mobile phone number) to receive the fax data.

In the implementation, the transmission-side image forming apparatus 200-2 may receive, from the cloud server 300, a fax number of the reception-side image forming apparatus 200-1, and transmit the fax data using a public switched telephone network (PSTN). Here, the PSTN is a communication network using international call system for transceiving voice data.

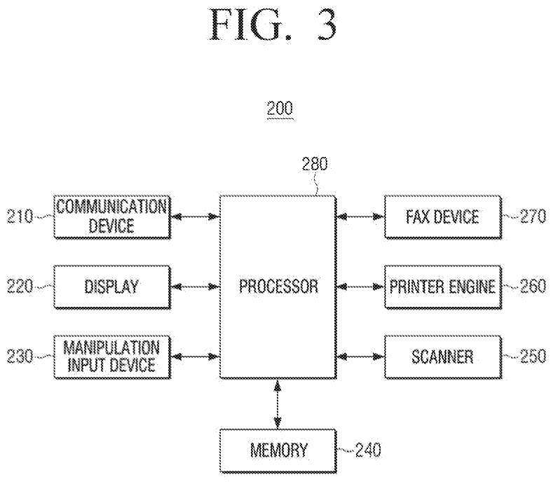

When the image forming apparatus 200 performs a fax receiving function, the image forming apparatus 200 may receive the fax data from the cloud server 300 as the reception-side image forming apparatus 200-1 of FIG. 1 and print the fax data. An example of a function and configuration of the image forming apparatus 200 will be described with reference to FIG. 3.

As described above, the image forming system 1000 according to an example may transceive fax, even if a user of the transmission side and the reception side does not know the fax number of the image forming apparatus the use would use, and thus, user convenience would be significantly improved.

The image forming system 1000 notifies the user of the fax reception, and may easily recognize the received fax. In addition, since the image forming system 1000 may output the received fax data using a selected image forming apparatus at a selected time, convenience of a user and data security would be improved.

In describing FIG. 1, although it has been illustrated and described that each configuration is directly connected, but in implementation, each device may be directly connected or indirectly connected through a router and other devices (for example, a server). In the illustrated example, each device is connected by wire, but it may be implemented as a wireless connection in implementation.

In describing FIG. 1, it has been described that the cloud server 300 is configured as a single device, but the cloud server 300 may be implemented as a plurality of servers. For example, the cloud server 300 may be implemented as a server for managing user information and a server for relaying fax transceiving.

In describing FIG. 1, it is described that the transmission-side image forming apparatus 200-2 transmits the fax data to the cloud server 300. However, in implementation, a user terminal device not having a printing function may transmit the print image (or file) to the cloud server 300 for performing fax transmission.

FIG. 2 is a block diagram illustrating a configuration of a user terminal device according to an example.

The user terminal 100 in FIG. 2 may be implemented as various types of electronic devices such as a TV, a PC, a laptop PC, a smartphone, a tablet PC, a personal digital assistant (PDA), an MP3 player, a kiosk, an electronic frame, or the like. In the case of implementation as a portable type device such as a smartphone, a tablet PC, a PDA, an MP3 player, a laptop PC or the like, the user terminal may be referred to as a mobile device, but it will be collectively referred to as a user terminal device in this Specification.

Referring to FIG. 2, the user terminal device 100 may be composed of a communication device 110, a touch screen 120, and a processor 130.

The communication device 110 may be formed to connect the user terminal device 100 to an external device (not shown), and may be connected to an external device through a local area network (LAN) and Internet network, but may also be connected to an external device through mobile communications (for example, global system for mobile (GSM), universal mobile telecommunication system (UMTS), long term evolution (LTE), wireless broadband (WiBRO), or the like).

The communication device 110 may transmit user information including information on the user terminal device to the cloud server 300.

The communication device 110 may transmit address information of an image forming apparatus to be used by the user to the cloud server 300. Here, the address information of the image forming apparatus may be at least one of an Internet protocol (IP) address of the image forming apparatus, a fax number of the image forming apparatus, or a multi access computer (MAC) number. At this time, the communication device 110 may transmit the option information related to the fax reception option to the cloud server 300.

Here, the option information may include at least one of an option whether to receive a fax notification and information on a communication network to be used by the image forming apparatus selected by the user.

The communication device 110 may receive a notification of fax reception from the cloud server 300. The notification may be received through the Internet network, or various other methods such as short message service (SMS) or e-mail may be used. The communication device 110 may be notified of the fact that the fax is received, and information about the received fax may be received together. Here, the information about the fax may be information on the transmission side of the fax, a preview image of the fax data, the image of the fax data itself, or the like.

The communication device 110 may request the output of the received fax to the cloud server 300. At this time, the communication device 110 may also transmit the information of the image forming apparatus which is to output the received fax data. For example, when the user does not designate the image forming apparatus to receive the fax, or decides to use an image forming apparatus different from the image forming apparatus which was designated before, the communication device 110 may transmit the address information of the image forming apparatus for outputting the currently received fax data to the cloud server 300, at the corresponding stage.

A touch screen 120 may display icons of several applications pre-installed in the user terminal device 100. The touch screen 120 may receive any one of the displayed icons of the several applications.

If the icon selected by the user is the APDS, the touch screen 120 may display a menu to receive a function that the APDS application supports. Here, the APDS application is an application capable of performing printing or fax printing by selecting an image forming device around the user.

The touch screen 120 may display predetermined information (for example, information on a currently-registered image forming apparatus, option information) related to the fax reception. Here, the user may change an option or an apparatus to be used for fax outputting on a displayed UI screen.

When the user performs an initial registration, or requests a change, the touch screen 120 may display a list of the searched peripheral image forming apparatuses that are connectable. In addition, the touch screen 120 may receive selection of an apparatus to be used for receiving a fax, among the displayed image forming apparatuses.

When a notification is received from the cloud server, the touch screen 120 may display that a fax is received. At this time, the touch screen 120 may display fax reception, or display information on the received fax data as well.

The user who recognizes the fax reception through the notification may select an output command of the touch screen 120 or determine an image forming apparatus to output the received fax.

The processor 130 controls each configuration in the user terminal device 100. As an example, the processor 130 may operate the APDS application if the user selects the APDS application. If the APDS application is operated, the processor 130 may control the touch screen 120 so that the UI provided in the APDS application is displayed.

When setting of an image forming apparatus to be used for fax reception is necessary, the processor 130 may search a peripheral image forming apparatus which is available. The search may use peer to peer (P2P) communication (for example, WiFi Direct, Bluetooth, or the like).

When the search is completed, the processor 130 may control the touch screen 120 to display the search result, and control the communication device 110 so that address information of the image forming apparatus selected by the user is transmitted to the cloud server 300.

When fax reception is notified from the cloud server 300 through such registration, the processor 130 may control the touch screen 120 to display that there is a fax reception. If the user terminal device 100 has a vibration function and a sound output function, the functions may be used together, and the notification may be displayed to the user.

When a print command for the received fax is input from the user, the processor 130 may control the communication device 110 to transmit the output command to the cloud server 300.

Though not illustrated, the user terminal device 100 may include a memory (not shown) for storing the address information described above and the APDS application, or the like.

As described above, according to an example, the user terminal device 100 may complete the registration of the image forming apparatus to be used for fax reception by the user, with an operation to search the vicinity and an operation to select one of the searched devices. Accordingly, even if the user does not know the fax number of the image forming apparatus to be used, the user may receive the fax. In addition, the user may be notified of the fax transmitted to the user and thus, user convenience would be improved.

FIG. 3 is a block diagram illustrating a configuration of an image forming apparatus according to an example.

Referring to FIG. 3, an image forming apparatus 200 may include a communication device 210, a display 220, a manipulation input device 230, a memory 240, a scanner 250, a printer engine 260, a fax device 270, and a processor 280.

The communication device 210 is formed to connect the image forming apparatus 200 with an external device, and may be connected through a local area network (LAN) and an Internet network but may also be connected through a universal serial bus (USB) port and a wireless module. Here, the wireless module may be WiFi, WiFi Direct, near field communication (NFC), Bluetooth, or the like.

The communication device 210 may transmit device information to the user terminal device 100. As an example, in response to the search in the user terminal device 100, the communication device 210 may transmit information (for example, device name, IP address, MAC information, or the like) of the image forming apparatus to the user terminal device 100.

The communication device 210 receives print data from an external device. At this time, the external device may be the user terminal device 100 but may also be the cloud server 300. That is, when the image forming apparatus 200 according to the example performs the fax reception function, the fax data may be received instead of the print data in the same manner as the method of receiving the print data.

The communication device 210 may transmit the fax number of the image forming apparatus for receiving the fax data, and transmit the user information for receiving the fax data instead of the fax number. When the user information is transmitted to the cloud server 300, a determination result regarding whether the image forming apparatus of the other side is a pre-registered device may be received.

The communication device 210 may transmit the fax data to the cloud server. The fax data transmitted herein may be print data pre-stored in the memory 240, which will be described later, or may be a scan image generated by the scanner 250. Here, the print data may be data in a printer language such as postscript (PS), printer control language (PCL), or the like, may be a file itself such as a portable document format (PDF), XML paper specification (XPS), Microsoft Windows device independent bitmap (BMP), and joint photographic experts group (JPG), or may be data having a fax format.

The communication device 210 may transmit user information to the cloud server. In response to the foregoing, the communication device 210 may receive an outputtable document list corresponding to the user information. The communication device 210 may transmit a file transfer command for the document selected by the user in the document list and receive the fax data corresponding to the file transfer command from the cloud server 300.

The display 220 may display various information provided by the image forming apparatus 200. The display 220 may be a display such as a monitor. In implementation, the display 220 may be implemented as a touch screen capable of performing a function of a manipulation input device 230 to be described later in a single device.

The display 220 may display a menu UI for receiving a selection of a function which the image forming apparatus may support. The display 220 displays a prestored telephone number. At this time, the display 220 may display an attribute (whether the number is a fax number) along with the pre-stored telephone number.

The display 220 may display a UI for receiving a selection of a content to be transmitted. The display 220 may display a received determination result.

The display 220 may display that user authentication is necessary. The display 220 may display a user interface window for performing authentication corresponding to the received user authentication information. For example, if the authentication information is a password, the display 220 may display a screen for receiving a password, and if the authentication information is near-field communication (NFC) information, the display 220 may display the guide information for the NFC tag.

The display 220 may display a list for fax data transmitted to a user. That is, the display 220 may display information on the outputtable fax data stored in the cloud server 300.

The manipulation input device 230 includes a plurality of function keys with which a user may set or select various functions supported by the image forming apparatus 200. The manipulation input device 230 may be implemented as a device such as a button, a touch pad, a mouse, and a keyboard, or a touch screen which may perform a function of the display 220 as well.

The manipulation input device 230 may receive an input of a fax transmission command from a menu displayed on the display 220.

The manipulation input device 230 may receive a selection of one of the displayed telephone numbers. At this time, if the selected telephone number is a fax number, an operation according to the example may be performed.

The manipulation input device 230 may receive a selection of a content through the displayed UI. The manipulation input device 230 may receive, from the user, an input of information for authentication such as a password. The manipulation input device 230 may select a document for performing an output operation.

The memory 240 may store the print data received through the communication device 210.

The memory 240 may store programs, data, or the like, for configuring various UIs constituting the UI window. The memory 240 stores various contents. Here, the content may be a document file (or print data) capable of printing and faxing, an image file (a scan image generated by the scanner), or the like.

The scanner 250 scans a manuscript and generates a scan image. As an example, the scanner 250 may include a light-emitting unit (not shown) which emits light onto a manuscript, a lens unit (not shown) which forms light reflected from a manuscript to an internal image sensor, an image sensor, or the like, and reads out image information of the manuscript from the light formed on the image sensor.

The scanner 250 may be a device which scans a manuscript placed on a flatbed, a device which scans one side or double sides of a manuscript fed by an automatic document feeder (ADF), or a device in which these two devices are combined.

The printer engine 260 prints the print data (or fax data) on the print paper. As an example, the printer engine 260 may print the print data received via the communication device 210 on the print paper using any one of the inkjet method, the dot-jet method, and the laser printer method. At this time, the print data may be data received through the communication device 210, scan data generated by the scanner 250, or fax data received by the fax device 270.

The fax device 270 includes a fax modem connected to the PSTN. The modem may have a fax line having a fax number. In the example, it has been described that one fax device 270 includes one fax modem, but in implementation, the fax device 270 may include a plurality of fax modems, that is, a plurality of fax lines.

The fax device 270 may convert data to the fax data. As an example, the fax device 270 may convert the prestored print data or scan data to fax formats (MH/MR/MMR/JBIG/JPEG) suitable for the fax transmission specification (T.30 protocol), and transmit the converted data to the other side's image forming apparatus through the PSTN.

At this time, the fax device 270 may incorporate pre-stored transmit terminal identification (TTI) into the existing print data or scan data and generate fax data. In illustrating FIG. 3, it has been illustrated and described that the image forming apparatus 200 includes the fax device, but in implementation, the fax device may be omitted.

The fax device 270 may receive the fax data through the PSTN, deliver the received fax data to the printer engine 260 for printing, or store the fax data in the memory 240.

The processor 280 controls each configuration in the image forming apparatus 200. As an example, the processor 280 may operate the APDS application when the user selects the APDS application. When the APDS application is operated, the processor 280 may control the display 220 to display the UI provided by the APDS application.

When receiving user information through the provided UI, the processor 280 may control the communication device 210 to transmit the input user information to the cloud server 300. In implementation, the processor 280 may control the communication device 210 so that pre-selected content (that is, fax data) is transmitted along the user information.

In response to providing the user information, if a result of determination on whether the other side's image forming apparatus is pre-registered is received from the cloud server 300, the processor 280 may control the display 220 to display the received determination result.

The processor 280 may control the communication device 210 to transmit the selected content to the cloud server 300.

In the meantime, if the user is not a pre-registered user, the processor 280 may receive the fax number to perform a fax transmission through the PSTN network from the user, convert the content into fax data of a fax format, and transmit the converted data to the cloud server 300. In implementation, format change, fax transmission through the PSTN network, or the like may be performed by the cloud server 300, instead of the image forming apparatus.

When the print data is received from the communication device 210, the processor 280 may control the printer engine 260 so that the received print data is printed.

As described above, the image forming apparatus 200 according to an example is capable of transceiving fax data, even if address information of a fax module is not known and thus, user convenience would be improved.

FIG. 4 is a block diagram illustrating a simple configuration of a cloud server according to an example.

Referring to FIG. 4, the cloud server 300 may include a communication device 310, a memory 330, and a processor 320. The cloud server 300 may be implemented as a general server device but may also be implemented as a private branch exchange (PBX).

The communication device 310 is formed to connect the cloud server 300 with an external device, and may be connected through local area network (LAN) and Internet network, but may also be connected through USB port and wireless module.

The communication deice 310 may receive user information from the user terminal device 100. As an example, the communication device 310 may receive account information for user account access from the user terminal device 100.

The communication device 310 receives information on a new image forming apparatus. As an example, the communication device 310 may receive, from the user terminal device 100, information on the image forming apparatus to be added to a user account.

The communication device 310 may receive fax data from the transmission-side image forming apparatus 200-2. The communication device 310 may notify the user terminal device 100 of the fact that the fax is received.

The communication device 310 may receive a request to output the fax data received from a subscriber. In response to the request, the communication device 310 may transmit the fax data to the image forming apparatus 200 designated by the subscriber. At this time, the communication device 310 may transmit the fax data using the communication network designated by the subscriber.

In the meantime, if the transmission of the fax data through the communication network designated by the user fails, the communication device 310 may retransmit the fax data using a communication network different from the communication network designated by the user. For example, if the fax data transmission using the PSTN fails, the communication device 310 may retransmit the fax data using the Internet network.

The memory 330 stores information on the user account. Here, the information on the user account is information including a telephone number corresponding to the user account, information on a user terminal device, information on an image forming apparatus selected by the user, or the like.

The memory 330 may store the received print data (or fax data). The memory 330 may store the fax data generated by the image processor 340 to be described later.

The memory 330 may store history of fax transmission request. As an example, the memory 330 may store the fax transmission request history by user accounts.

The memory 330 may be implemented as a storage medium in the cloud server 300 and an external storage medium, for example, a removable disk including an USB memory, a file server through network, or the like.

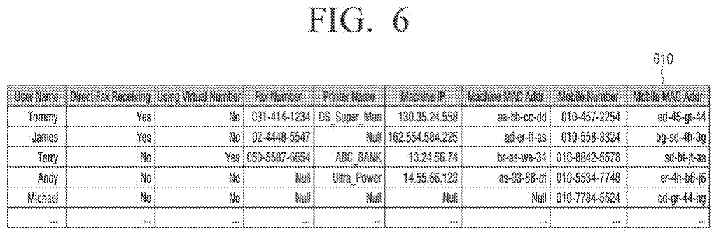

The processor 320 performs control for each configuration in the cloud server 300. As an example, when the processor 320 receives the user account information, the terminal device information, and the image forming apparatus information from the user terminal device, the processor 320 may map the corresponding information and store the information in a lookup table (or a mapping table) as FIG. 6.

When receiving the fax transmission request from the transmission-side user terminal device (not shown) or the transmission-side image forming apparatus 200-2, the processor 320 may determine whether a user corresponding to the fax transmission request is a pre-registered. subscriber.

When a user corresponding to the fax transmission request is not a subscriber, the processor 320 may control the communication device 310 to notify that the address information of the transmission-side image forming apparatus is necessary.

In an example, when the user is a subscriber, and the pre-registered communication network is the PSTN, the processor 320 may control the communication device 310 to transmit the fax number of the user to the transmission-side image forming apparatus 200-2. Meanwhile, in implementation, it is possible that the cloud server 300 receives the fax data, and the cloud server 300 transmits the fax data to the reception-side image forming apparatus 300-1 through the PSTN.

On the contrary, if the user corresponding to the fax transmission request is a subscriber, the processor 320 may notify that fax transmission is possible without additional information. Accordingly, when receiving the fax data from the transmission-side user terminal device (not shown) or the transmission-side image forming apparatus 200-2, the processor 320 may control the communication device 310 to notify the user terminal device 100 corresponding to the subscriber of the fax reception.

When receiving the fax data from the transmission-side image forming apparatus 200-2, the processor 320 may store the received fax data in the memory 330. The processor 320 may manage the stored fax data. For example, when a predetermined period of time has elapsed since the reception of the fax data, or when the storage capacity allocated to the user is exceeded, the processor 320 may perform a management operation to delete the prestored fax data.

The processor 320 may control the communication device 310 to transmit the fax data received according to a request of the corresponding user to the reception-side image forming apparatus 200-1. Such request of the subscriber may be provided to the cloud server 300 by various methods.

First, the user terminal device 100 side which is notified of reception of the fax data may receive a request of output of the received fax data, or receive a request of output of the received fax data which the user selects to output by the image forming apparatus 200-1. When the user selects an option to perform output immediately, even if there is no additional confirmation request in advance, the processor 320 may transmit the received fax data immediately to the reception-side image forming apparatus 200-1.

When a fax output is requested, the processor 320 may determine a communication network to be used for communication with the image forming apparatus, and transmit the fax data to the image forming apparatus using the determined communication network. Here, the communication network may include the PSTN network and the Internet network. The Internet network is a communication network in which computers from all over the world are interconnected and access the Internet where the computers may exchange information from each other. The PSTN and the Internet network are described as examples of the communication network, but another communication network capable of transmitting fax data other than the above-mentioned communication network may be used.

When the user registers the PSTN as a communication network to be used based on pre-registered option information, the processor 320 may control the communication device 310 to transmit the received fax data to the reception-side image forming apparatus 200-1 through the PSTN.

On the contrary, if the user registers the Internet network as a communication network to be used, the cloud server 300 may control the communication device 310 to transmit the fax data to the reception-side image forming apparatus 200-1 through the Internet network.

The processor 320 may store the history of the fax transmission request described above in the memory 330 as history information.

Hereinabove, a simple configuration of the cloud server 300 has been illustrated and described, but the cloud server 300 may further include a configuration other than the above configurations. Further configurations of the cloud server 300 will be described below with reference to FIG. 5.

FIG. 5 is a block diagram illustrating a detailed configuration of a cloud serve according to an example.

Referring to FIG. 5, the cloud server 300 may include a communication device 310, a processor 320, a memory 330, an image processor 340, and a fax device 350.

The operations of the communication device 310 and the memory 330 are the same as the operations of each configuration in FIG. 4, and the overlapping description will be omitted. The operation of the processor 340 has been described with reference to FIG. 4, and the additional configuration will be further described.

The image processor 340 may convert the received data into fax data. As an example, the image processor 340 may convert the prestored print data or scan data into a fax format (MH/MR/MMR/JBIG/JPEG) conforming to the T.30 protocol. At this time, the image processor 340 may incorporate the pre-stored TTI into the received data to generate fax data. In implementation, the image processor 340 may be a configuration within the fax device 350, or may be implemented as a functional block of the processor 320.

The fax device 350 includes a fax modem connected to the PSTN network. The modem has a fax line having a fax number. In this example, it has been described that one fax device 350 includes one fax modem, but in implementation, the fax device 350 may include a plurality of fax modems, that is, a plurality of fax lines.

If it is determined that the fax data is transmitted through the PSTN, and the received fax data does not have a fax format to use the PSTN, the processor 320 may change the received fax data to the fax format suitable to the fax transmission specification. The processor 320 may then control the fax device 350 to send the format-changed fax data through the PSTN.

As described above, the cloud server 300 according to an example performs a notification function of notifying the user terminal device 100 of receiving a fax, so that the user may easily recognize the reception of the fax. Also, the cloud server 300 performs the operation of transmitting the received fax data to the image forming apparatus based on the user's confirmation operation, the convenience of the user and the fax data security may be improved.

In illustrating FIG. 5, it has been illustrated and described as if the fax device 350 and the communication device 310 are separate configurations, but in implementation, the fax device 350 may be a configuration in the communication device 310.

FIG. 6 is a view illustrating an example of account information stored in a memory of FIG. 4.

Referring to FIG. 6, account information 610 includes user information, address information of the user terminal device, information and option information of an image forming apparatus.

As an example, as for the user information, a user name may be used for information which specifies a user, and ID, an employee number, or the like, may be stored additionally.

The address information of the user terminal device may be address information (for example, MAC address, telephone number, or the like) of a user terminal device which is to receive a notification of fax reception.

The address information of the image forming apparatus may be address information (for example, fax number, MAC address) of the image forming apparatus to receive the fax data. The address information of the image forming apparatus may be easily changed according to the user's selection in the user terminal device 100. When the changed address information is received from the user terminal device 100, the cloud server 300 may update the address information of the image forming apparatus for the user based on the received address information.

The option information means an option to transmit fax data immediately to the image forming apparatus without user confirmation. In the meantime, in implementation, an option may be set regarding whether the notification providing function as described above will be performed.

In FIG. 6, the virtual number is information indicating that the fax number of the image forming apparatus is a virtual telephone number rather than an actual fax number. As an example, the virtual number is one of many fax numbers managed by the cloud server 300 and is a number allocated by the cloud server 300 performing the exchange network function according to the request of the user.

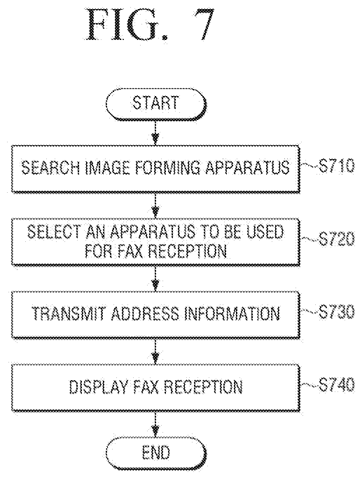

FIG. 7 is a flowchart to describe a fax notification method in a user terminal device according to an example.

Referring to FIG. 7, a user terminal device searches a connectable image forming apparatus in operation S710.

Then, an apparatus to be used for receiving a fax among the searched image forming apparatuses is selected in operation S720. As an example, the user terminal device 100 may search for connectable image forming apparatuses around the user terminal device 100 using the P2P wireless communication system, display information of the searched image forming apparatuses to the user, and receive a selection of one of the displayed image forming apparatuses from the user.

The address information of the user terminal device and the address information of the image forming apparatus are transmitted to the cloud server in operation S730. As an example, the address information (for example, IP address, and fax number) of the image forming apparatus selected by the user and the address information of the user terminal device may be transmitted to the cloud server 300.

If the fax reception is notified from the cloud server, reception of the fax data is displayed in operation S740. At this time, the user terminal device may be notified of the fact that the fax data has been received from the cloud server 300, or also receive information (for example, sender information, fax data itself, thumbnail for fax data, or the like) on the fax data, and display the information together.

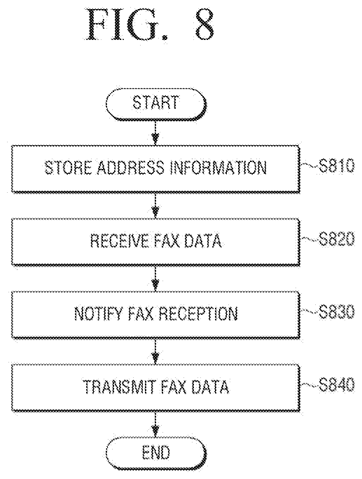

FIG. 8 is a flowchart to describe a fax notification method in a cloud server according to an example.

Referring to FIG. 8, address information of a user terminal device corresponding to a subscriber is stored in operation S810. At this time, the address information of the image forming apparatus to be used by the subscriber may be received from the user terminal device together, and when the communication network information to be used for fax reception is received as well, the communication network information may be mapped and stored as a look-up table.

The fax data for the subscriber is received in operation S820. At this time, the fax data is general print data, a file itself, or data encoded to be a fax format.

Based on the address information of the user terminal device, fax reception is notified to the user terminal device corresponding to the subscriber in operation S830. At this time, the information on the fax data may also be transmitted to the user terminal device 100.

When output of the received fax data is requested from the subscriber, the fax data may be transmitted to an image forming apparatus designated by the subscriber in operation S840. As an example, the communication network may be determined based on communication network information, and fax data may be transmitted using the determined communication network. Here, the image forming apparatus to receive the fax data may be an image forming apparatus pre-registered by the subscriber in the previous process, or an image forming apparatus designated by the user at the time of requesting output of the fax data. Here, the image forming apparatus designated by the user may be a device designated by the user terminal device 100, or may be a device to which a user directly logs in by moving to the image forming apparatus.

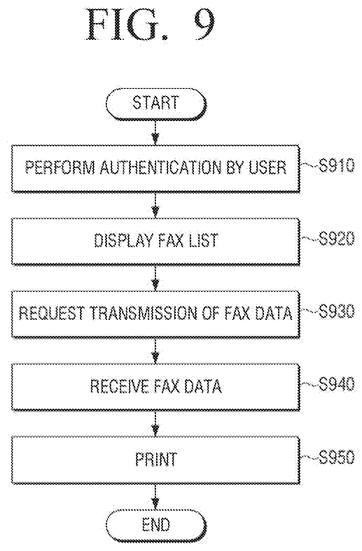

FIG. 9 is a flowchart to describe a method of outputting fax data according to an example.

Referring to FIG. 9, when the user performs authentication in the image forming apparatus 200 in operation S910, the cloud server 300 may provide a list for the fax data transmitted to the user to the corresponding image forming apparatus 200.

Accordingly, the image forming apparatus 200 may display a received list, that is, a fax list in operation S920.

When the user selects fax data in the displayed list, the image forming apparatus 200 may request transmission of the selected fax data to the cloud server 300 in operation S930.

When the fax data is received, in response to the above request in operation S940, the image forming apparatus 200 may print the received fax data.

As described above, the fax notification method according to an example may inform a user of fax reception and accordingly, a user may easily recognize fax which is transmitted to the user. In addition, a fax notification method and outputting method according to an example enables outputting the fax data transmitted to the fax at a selected image forming apparatus at a selected time, and thus, convenience and security would be improved.

In addition, the control method of the image forming apparatus as described above may be implemented as at least one execution program for executing the control method of the image forming apparatus as described above, and the execution program may be stored in a non-transitory computer readable medium.

Non-transitory readable medium means a medium that stores data for a short period of time such as a register, a cache, and a memory, but semi-permanently stores data and is readable by the apparatus. In particular, the various applications or programs described above may be stored and provided on non-volatile readable media such as CD, DVD, hard disk, Blu-ray disk, USB, memory card, ROM.

Although the examples of the disclosure have been illustrated and described hereinabove, the disclosure is not limited to the abovementioned examples, but may be variously modified by those skilled in the art to which the disclosure pertains without departing from the scope and spirit of the disclosure as disclosed in the accompanying claims. These modifications should also be understood to fall within the scope of the disclosure.

1. A cloud server comprising:
a memory storing address information of a user terminal device corresponding to a subscriber;
a communication device to receive fax data; and
a processor to, in response to receiving the fax data for the subscriber, control the communication device to notify the user terminal device a fax was received based on the address information of the user terminal device, and in response to receiving a request to output the received fax data, control the communication device to transmit the received fax data to an image forming apparatus designated by the subscriber.

2. The cloud server of claim 1,
wherein the processor, in response to receiving address information of the image forming apparatus to be used by the subscriber from the user terminal device, is to store the received address information of the image forming apparatus in the memory, and
the processor, in response to receiving the request to output the received fax data from a subscriber having address information of an image forming apparatus, is to control the communication device to transmit the received fax data to the stored address information of the image forming apparatus.

3. The cloud server of claim 2,
wherein the processor:
is to store option information including communication network information, and
is to determine a communication network to communicate with the image forming apparatus based on the communication network information, and is to control the communication device to transmit the received fax data to the image forming apparatus using the determined communication network.

4. The cloud server of claim 3,
wherein the processor, in response to the fax transmission using the determined communication network failing, is to control the communication device to re-transmit the received fax data using a communication network different from the determined communication network.

5. The cloud server of claim 1,
wherein the processor, in response to receiving a fax output request including address information of an image forming apparatus from the user terminal device notified of the fax reception, is to control the communication device to transmit the received fax data to the address information of the image forming apparatus included in the fax output request.

6. The cloud server of claim 1,
wherein the processor, in response to receiving identification information of the subscriber from an image forming apparatus, is to control the communication device to transmit fax data corresponding to the subscriber identification information to the image forming apparatus transmitting the subscriber identification information.

7. The cloud server of claim 1,
wherein the processor, in response to receiving a fax transmission request from a transmission-side user terminal device or a transmission-side image forming apparatus, is to determine whether a receiving side corresponding to the fax transmission request is a pre-registered subscriber, and is to control the communication device to notify the transmission-side user terminal device or the transmission-side image forming apparatus transmitting the fax transmission request of the determination result about whether the receiving side user is a pre-registered subscriber.

8. The cloud server of claim 1,
wherein the processor is to control the communication device to notify the user terminal device corresponding to the subscriber of information corresponding to the fax data together, and
wherein the information corresponding to the fax data comprises at least one of transmission-side information, a preview image of the fax data, or image data corresponding to the fax data.

9. A fax notification method of a cloud server, the method comprising:
storing address information of a user terminal device corresponding to a subscriber;
receiving fax data for the subscriber;
in response to receiving the fax data, notifying the user terminal device a fax was received based on the address information of the user terminal device;
receiving a request to output the received fax data from the subscriber; and
in response to receiving the request, transmitting the received fax data to an image forming apparatus designated by the subscriber.

10. The fax notification method of claim 9,
wherein the storing further includes storing the received address information of the image forming apparatus in response to receiving address information of the image forming apparatus to be used by the subscriber from the user terminal device,
wherein the receiving a request comprises receiving a request to output the received fax data from a subscriber having address information of an image forming apparatus, and
wherein the transmitting comprises transmitting the received fax data to the stored address information of the image forming apparatus.

11. The fax notification method of claim 10,
wherein the storing further comprises storing option information including communication network information,
wherein the fax transmission method further comprises:
determining a communication network to communicate with the image forming apparatus based on the communication network information, and
wherein the transmitting comprises transmitting the received fax data to the image forming apparatus using the determined communication network.

12. The fax notification method of claim 11, comprising:
in response to the fax transmission using the determined communication network failing, re-transmitting the received fax data using a communication network different from the determined communication network.

13. The fax notification method of claim 9,
wherein the receiving a request comprises receiving a fax output request including address information of an image forming apparatus from the user terminal device notified with the fax reception, and
wherein the transmitting comprises transmitting the fax data to the address information of the image forming apparatus included in the fax output request.

14. The fax notification method of claim 9,
wherein the receiving a request comprises receiving identification information of the subscriber from an image forming apparatus, and
wherein the transmitting comprises transmitting fax data corresponding to the subscriber identification information to the image forming apparatus transmitting the subscriber identification information.

15. A computer readable medium including a program to execute a fax notification method comprising:
searching for a connectable image forming apparatus from a user terminal device;
receiving a selection of an apparatus to be used to receive a fax among the searched image forming apparatuses;
transmitting address information of the user terminal device and address information of the image forming apparatus to a cloud server; and
in response to being notified from the cloud server the fax was received, displaying reception of the fax.
